(19) United States
(12) Patent Application Publication
(10) Pub. No.: US 2011/0048363 A1
(43) Pub. Date: Mar. 3, 2011

(54) CYLINDER

(75) Inventors: Jens-Thorsten Gronau, Hameln (DE); Mike Heurich, Apelern (DE); Christian Seestädt, Hannover (DE); Tino Wiggers, Seelze (DE)

(73) Assignee: WABCO GMBH, Hannover (DE)

(21) Appl. No.: 12/736,017

(22) PCT Filed: Feb. 4, 2009
(86) PCT No.: PCT/EP2009/000731

§ 371 Date: Nov. 3, 2010

(30) Foreign Application Priority Data
Mar. 15, 2008 (DE) 10 2008 014 506.8

(51) Int. Cl. F02F 3/00

(52) U.S. Cl. 123/193.6

(57) ABSTRACT

The invention relates to a cylinder having a piston (14) moving in a cylinder housing (12), said piston being fastened to a cylinder rod (16) and rotatable about a cylinder longitudinal axis (L), and further having a position sensor (18), comprising a sensor magnet (20) and a sensor element (22), which interacts with the sensor magnet (20), and which is configured for detecting a cylinder rod position relative to the cylinder housing (12). The invention provides that the sensor magnet (20) is fastened on the cylinder rod rotatably with respect to the cylinder rod (16) and is guided non-rotatably with respect to the cylinder housing (12).

The invention relates to embodiments of a cylinder having a piston which runs in a cylinder housing and is fastened to a cylinder rod and can be rotated about a cylinder axis, and a position sensor which comprises a sensor magnet and a sensor element which interacts with the sensor magnet, the sensor magnet being configured for detecting a cylinder-rod position relative to the cylinder housing. In addition, sensors which are arranged adjacently can be disrupted by the part magnets.

A piston of the general type under consideration is described in DE 20 2005 005 508 U1. Here, part magnets which complement one another to form a magnetic ring are arranged on the piston, the magnetic field of which part magnets is detected by a magnetic field sensor. A disadvantage of the piston is its high production cost.

DE 20 2007 001 020 U1 has disclosed a fluidic cylinder having a position detection device for the piston position. It is also disadvantageous here that the cylinder is complicated to produce and difficult to maintain.

The claimed invention is based on the object of specifying a cylinder which is easy to produce, is additionally simple to maintain and influences surrounding sensors to a less pronounced extent.

The foregoing problem can be solved by way of embodiments of a cylinder of the generic type, in which the sensor magnet is fastened to the cylinder rod such that it can be rotated with regard to the cylinder rod, and is guided in a rotationally fixed manner with regard to the cylinder housing.

It is advantageous here that a cylinder of this type is simple to produce. For instance, a standard cylinder can be used, to which only the special position sensor has to be fastened. It is a further advantage that the position sensor does not require any additional installation space at all in the circumferential direction, with the result that the cylinder is of narrow design in the circumferential direction.

It is a further advantage that a very small magnet can be used, which reduces the production costs. At the same time, leakage fields are reduced considerably, as a result of which surrounding sensors are influenced to a lesser extent.

In the context of the present description, a cylinder rod is understood as meaning, in particular, every component which is coupled fixedly to the piston with regard to the actuating direction of the piston. For instance, the cylinder rod can comprise a plurality of part cylinder rods which are fastened to one another in a push-stable manner or by joints. The feature that an object is arranged in a rotationally fixed manner with regard to another object is to be understood, in particular, as meaning that free rotation, for example by several revolutions, is not possible. However, that does not rule out pivoting being possible by a small angular range, for example less than 20°.

According to one preferred embodiment, the sensor magnet extends exclusively over a fraction of a cylinder-rod circumferential angle of the cylinder rod. Since the sensor magnet is guided in a rotationally fixed manner with regard to the cylinder housing, it is merely necessary that the sensor magnet always faces the sensor element. On a side of the cylinder rod which faces away from the sensor element, no magnetic element is necessary and possibly even damaging, since surrounding sensors can be influenced. It is advantageous here that the magnetic element can be produced to be small and therefore inexpensive. It is a further advantage that the magnetic field which surrounds the sensor magnet is present only in the immediate vicinity of the sensor element. As a result, magnetic interference fields are avoided which otherwise can disrupt other sensors which are arranged in the vicinity. It is additionally advantageous that a small sensor magnet is also influenced less by external magnetic fields, which for its part increases the measuring accuracy.

It has proven sufficient and advantageous if the sensor magnet extends over less than a third, in particular less than a fifth, of the cylinder-rod circumferential angle of the cylinder rod. It is even possible that the sensor magnet extends over the cylinder-rod circumferential angle by less than 70° or even less than 45°.

A sensor magnet which is particularly simple to produce is obtained if it is circular segment-shaped. It is particularly advantageous here that a sensor magnet of this type with a given magnetic field strength is of particularly small design radially.

A structurally particularly simple piston is obtained if the sensor magnet is fastened to an adapter, the adapter being free of magnetized material on a side which faces away from the sensor element and being fastened to the cylinder rod such that it cannot be displaced in at least one direction with regard to the cylinder-rod longitudinal direction. As a result of the fact that the adapter is free of magnetized material on a side which faces the sensor element, spatially extensive magnetic fields are avoided which can disrupt magnetic field sensors which are positioned in the surrounding area. In addition, the cylinder can be produced particularly simply and inexpensively by the omission of magnetized material. The feature that the adapter is fastened to the cylinder rod such that it can be displaced in at least one direction with regard to the cylinder-rod longitudinal direction is to be understood, in particular, as meaning that a movement of the piston in at least one direction always leads to a movement of the adapter in the same direction. In other words, the adapter is driven by the cylinder rod in at least one direction.

The adapter is preferably guided in a guide sleeve in a rotationally secured manner about the cylinder-rod longitudinal direction. This is to be understood, in particular, as meaning that the guide sleeve is at a standstill relative to the cylinder housing, with the result that the adapter cannot perform a rotational movement relative to the cylinder housing. However, a pivoting movement by a few degrees can be possible. To this end, it is not necessary that the cylinder housing and the guide sleeve are connected directly to one another. For instance, it is possible that, for example, the cylinder housing and the guide sleeve are fastened jointly to a third object.

A construction which is particularly simple and relatively insusceptible to disruptions is obtained if the adapter has a guide groove, into which a guide projection of the guide sleeve engages. It goes without saying that it is also possible as an alternative or in addition that the adapter has a guide projection which engages into a recess in the guide sleeve.

The cylinder rod preferably has a stop for the adapter, the piston comprising a spring, in particular a helical spring, which is fastened in a rotationally secured manner relative to the cylinder housing and prestresses the adapter against the stop. Here, the adapter is fastened to the spring in a rotationally secured manner, with the result that the adapter is rotationally secured relative to the cylinder housing. There is provision, for example, for the helical spring to surround the cylinder rod and to be fastened, for example clipped, to the adapter. On the side which lies opposite the adapter, the helical spring is then mounted in a rotationally fixed manner relative to the cylinder housing. The adapter can thus perform small pivoting movements about the cylinder-rod longitudinal axis, but is always pressed back into a rest position by the spring. This construction has the advantage of being particularly simple to produce and to maintain.

The use of an above-described piston is particularly advantageous in a gear actuator for an automatic or semi-automatic gearbox. Here, the cylinder can preferably be configured for shifting a gate of the gearbox. In a gear actuator of this type, neither a gate rod which serves to shift the gate nor the cylinder to actuate it may be of rotationally fixed configuration. In known gear actuators, ring magnets are therefore provided which interact with the sensor element. However, it has been shown that these ring magnets can influence surrounding sensors, for example a gear sensor for determining a gear position of the gearbox or a split sensor for determining a shifting position of a split stage of the gearbox. This problem is avoided by way of a cylinder according to the invention which can be a pneumatic cylinder or a hydraulic cylinder.

The position sensor is preferably configured as a gate sensor which detects a position of a gate rod of the gearbox. In this case, the sensor magnet is a gate sensor magnet and the sensor element is a gate sensor element. The sensor elements are preferably magneto-inductive sensor elements, in particular PLCD sensor elements (PLCD=permanent-magnet linear contactless displacement).

In the following text, one exemplary embodiment of the invention will be explained in greater detail using the appended drawings, in which:

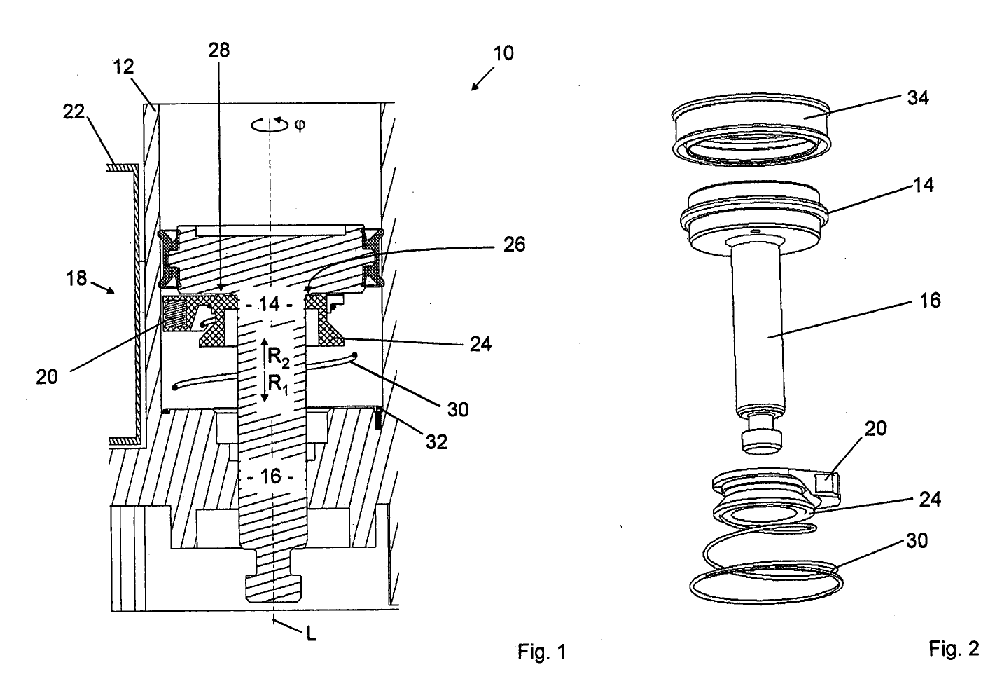

FIG. 1 shows a cross section through a cylinder according to the invention,

FIG. 2 shows an exploded illustration of the cylinder according to FIG. 1,

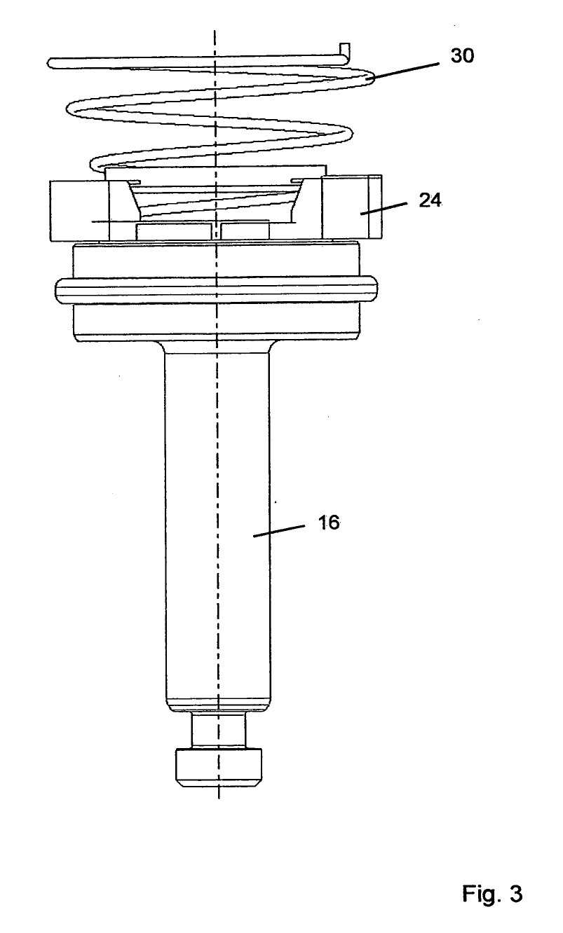

FIG. 3 shows a side view of part of the components of a cylinder according to the invention according to a second embodiment,

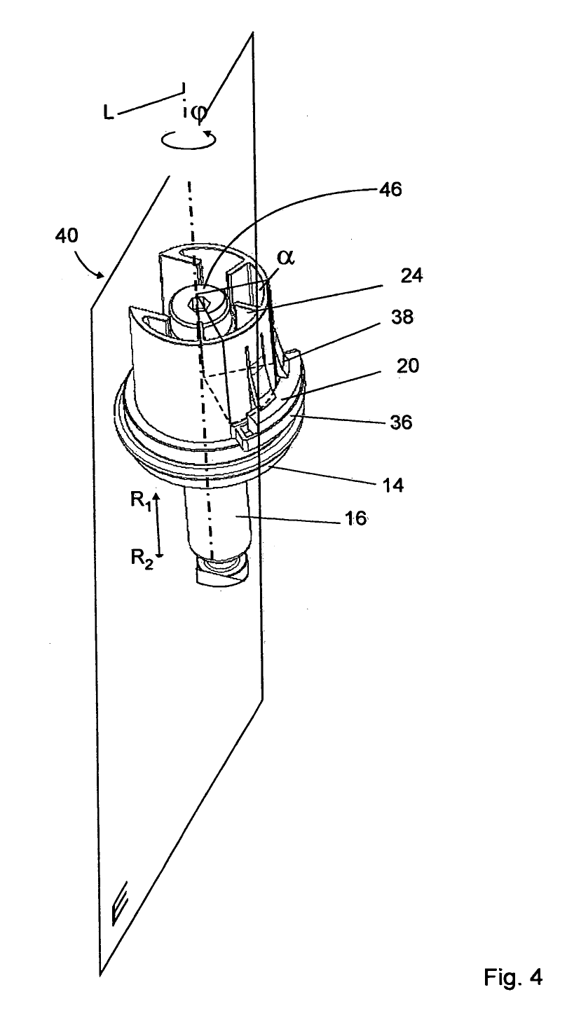

FIG. 4 shows a second embodiment of a cylinder according to the invention which is part of a gear actuator according to the invention, and

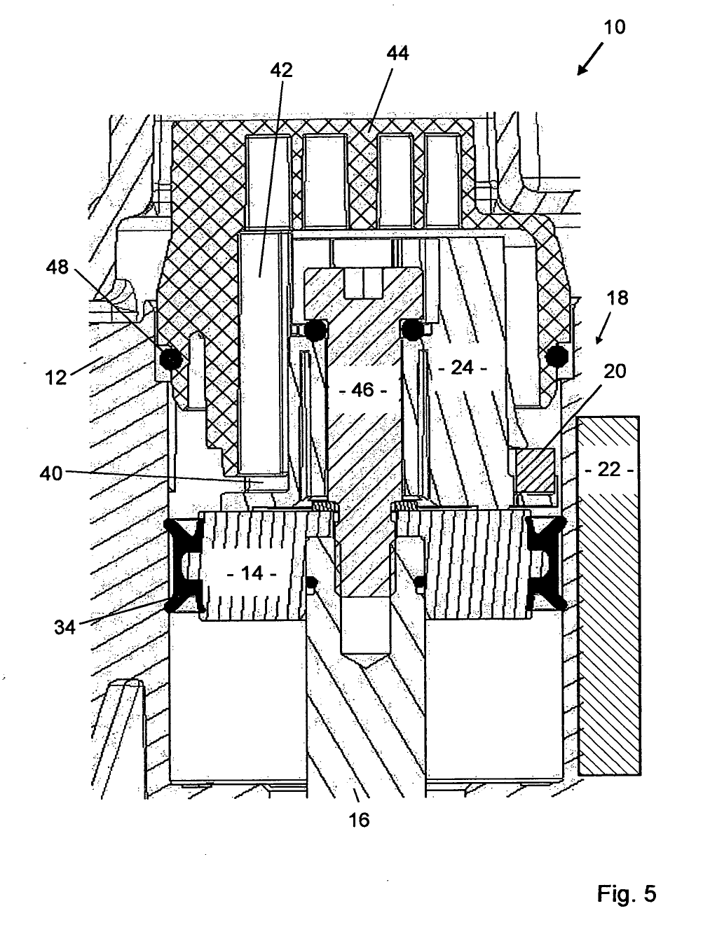

FIG. 5 shows a detailed cross-sectional view of the cylinder according to FIG. 4.

FIG. 1 shows a cylinder 10 having a piston 14 which runs in a cylinder housing 12, is fastened to a cylinder rod 16 and is fastened such that it can be rotated about a cylinder-rod longitudinal axis L.

In addition, the cylinder 10 comprises a position sensor 18 which comprises a sensor magnet 20 and a sensor element 22 which interacts with the sensor magnet 20. The position sensor 18 is configured in such a way that it measures the position of the piston 14 at a level with respect to the cylinder-rod longitudinal axis L.

The piston 14 can be rotated with regard to the cylinder housing 12 about the longitudinal axis L by a rotary angle φ. The sensor magnet 20 is always arranged opposite the sensor element 22 with regard to the cylinder housing 12 by the said sensor magnet 20 being arranged in a rotationally fixed manner with regard to the cylinder housing 12. To this end, the sensor magnet is fastened to an adapter 24. For example, the sensor magnet 20 is injection-moulded, adhesively bonded or clipped into the adapter 24. The piston 14 and the cylinder rod 16 can be rotated relative to the adapter 24. The adapter 24 is mounted on the cylinder rod 16 such that it can be displaced in a first direction R₁ along the cylinder-rod longitudinal axis L. To this end, the adapter 24 surrounds the cylinder rod annularly and forms a clearance fit 26 with the cylinder rod 16.

The adapter 24 cannot be moved relative to the piston 14 with regard to a second direction R₂ which opposes the first direction R₁, since the said adapter 24 comes into contact with a stop 28 which is formed by a surface of the piston 14.

The adapter 24 is a plastic injection-moulded part which is non-magnetic and cannot be magnetized, with the result that a permanent magnetic field exists only in a surrounding area of the sensor magnet 20. The sensor element 22 is configured in order to measure this magnetic field along the cylinder longitudinal axis L in a spatially resolved manner and in order to determine from this the position of the piston 14. A helical spring 30 is attached, for example clipped, to the adapter 24. As a result, the helical spring is fastened in a rotationally fixed manner to the adapter 24. The helical spring 30 is fastened in a rotationally fixed manner to the cylinder housing 14 in a receiving groove 32 by way of its end which faces away from the adapter 24. As a result, the sensor magnet 20 can pivot about the cylinder longitudinal axis L to the extent of a few degrees, but is always returned to a predefined rotary angle position by the helical spring 30.

FIG. 2 shows an exploded illustration of the components which are arranged in the cylinder housing 12, it also being possible to see a rubber seal 34 of the piston 14. It can be seen that the sensor magnet 20 extends only by a fraction of a cylinder-rod circumferential angle of the cylinder rod 16. In other words, a multiplicity of sensor magnets 20 could be arranged behind one another in the circumferential direction, until the cylinder rod 16 were surrounded completely radially by sensor magnets 20. The determination of the cylinder-rod circumferential angle will be explained in greater detail further below in conjunction with FIG. 4.

FIG. 3 shows the components of a second embodiment of a cylinder according to the invention. In this embodiment, unlike in the embodiment according to FIG. 2, the cylinder rod 16 reaches through neither the adapter 24 nor the helical spring 30. In both embodiments, both according to FIG. 2 and according to FIG. 3, the adapter 24 with the sensor magnet 20 and the helical spring 30 are arranged in the cylinder housing 12. As an alternative, however, it is also possible that the adapter 24 and the helical spring 30 are arranged outside the cylinder housing 12.

FIG. 4 shows a further embodiment of a cylinder according to the invention, the cylinder housing 12 having been omitted for the sake of clarity. The cylinder rod 16 reaches through the adapter 24 which secures the circular segment-shaped sensor magnet 20. To this end, the adapter 24 has a sensor-magnet receptacle 36 and a clamping projection 38. The sensor magnet 20 is received in the sensor-magnet receptacle 36 and is held fixedly by the clamping projection 38.

The adapter 24 can once again be pivoted freely about the cylinder-rod longitudinal axis L of the cylinder rod 16 by the rotary angle φ. In addition, the sensor magnet 20 extends over a cylinder-rod circumferential angle α which is defined as illustrated. To this end, a measuring plane E is defined, through which the cylinder-rod longitudinal axis L extends. The cylinder-rod circumferential angle α is that angle which exists between two measuring planes E which just touch the outer sides of the sensor magnet 20. The smaller the cylinder-rod circumferential angle α is, the less any surrounding sensors are influenced negatively by leakage fields. In FIG. 4, α is approximately 90°.

In the embodiment according to FIG. 4, the adapter 24 has a guide groove 40, into which a guide lug 42 (cf. FIG. 5) of a guide sleeve 44 engages.

As FIG. 4 shows, the adapter 24 is connected fixedly to the piston 14 via a screw 46 and thus cannot move relative to the piston 14. The piston 14 can be rotated with respect to the piston rod 16, with the result that the adapter 24 can also be rotated with regard to the cylinder axis. In other words, the cylinder rod 16 can be rotated with regard to the adapter 24 and therefore with regard to the sensor magnet 20.

FIG. 5 shows a cross section through the cylinder 10, the inner components of which are shown in FIG. 4. It can be seen that the guide sleeve 44 is attached to an end of the cylinder housing 14 and is sealed with respect to the latter by way of an O-ring 48. In FIG. 5, the rubber seal 34 is attached directly to the piston 14. However, it is also conceivable that the rubber seal 34 is attached to the adapter 24. In addition, it is possible that, as in the first embodiment described, the adapter 24 can be turned relative to the piston 14, with the result that the piston can rotate in the cylinder housing 12, without the sensor magnet 20 being removed from its position opposite the sensor element 22. In addition, it is possible that the adapter 24 represents an integral constituent part of the piston 14.

As a result of the guide lug 42 engaging into the guide groove 40 of the adapter 24, the cylinder rod 16 can rotate freely in relation to the cylinder housing, and the sensor magnet is nevertheless guided in a rotationally fixed manner with regard to the cylinder housing 12.

1. Cylinder having
(a) a piston (14) which runs in a cylinder housing (12) and
(i) is fastened to a cylinder rod (16) and
(ii) can be rotated about a cylinder longitudinal axis (L), and
(b) a position sensor (18) which
(i) comprises a sensor magnet (20) and
(ii) a sensor element (22) which interacts with the sensor magnet (20), and
(iii) is configured for detecting a cylinder-rod position relative to the cylinder housing (12),
characterized in that
(c) the sensor magnet (20)
(i) is fastened to the cylinder rod such that it can be rotated with regard to the cylinder rod (16), and
(ii) is guided in a rotationally fixed manner with regard to the cylinder housing (12).

2. Cylinder according to claim 1, characterized in that the sensor magnet (20) extends exclusively over a fraction of a cylinder-rod circumferential angle (α) of the cylinder rod (16).

3. Cylinder according to claim 2, characterized in that the sensor magnet (20) extends over less than a third, in particular less than a fifth, of the cylinder-rod circumferential angle (α) of the cylinder rod (16).

4. Cylinder according to either of claims 2 and 3, characterized in that the sensor magnet (20) is circular segment-shaped.

5. Cylinder according to one of the preceding claims, characterized in that the sensor magnet (20) is fastened to an adapter (24), and the adapter (24)
(i) is free of magnetized material on a side which faces away from the sensor element (22), and
(ii) is fastened to the cylinder rod (16) such that it cannot be displaced in at least one direction with regard to the cylinder-rod longitudinal direction.

6. Cylinder according to one of the preceding claims, characterized in that the adapter (24) is guided in a guide sleeve (44) in a rotationally secured manner about the cylinder-rod longitudinal axis (L).

7. Cylinder according to claim 6, characterized in that the adapter (24) has a guide groove (40), into which a guide lug (42) of the guide sleeve (44) engages.

8. Cylinder according to one of claims 1 to 5, characterized in that
(i) the cylinder rod (16) has a stop (28) for the adapter (24), and
(ii) the piston (14) comprises a spring (30), in particular a helical spring, which is fastened in a rotationally secured manner relative to the cylinder housing (12) and prestresses the adapter (24) against the stop (28),
(iii) the adapter (24) being fastened to the spring (30) in a rotationally secured manner, with the result that the adapter (24) is rotationally secured relative to the cylinder housing (12).

9. Gear actuator for a gearbox, characterized in that it comprises a cylinder (10) according to one of the preceding claims, the cylinder (10) being configured for shifting a gate and the cylinder rod (16) being coupled to a gate rod of the gearbox.

10. Gearbox having a gear actuator according to claim 9.
